(19) United States
(12) Patent Application Publication
(10) Pub. No.: US 2016/0071258 A1
(43) Pub. Date: Mar. 10, 2016

(54) Responsibility system, ID and Tracking of items and debris including retread tires

(71) Applicant: Guy L. McClung, III, San Antonio, TX (US)

(72) Inventor: Guy L. McClung, III, San Antonio, TX (US)

(21) Appl. No.: 14/121,464

(22) Filed: Sep. 8, 2014

(51) Int. Cl. G06T 7/00; G06Q 30/02; G06K 9/46; G06Q 40/08; G06K 9/62; G06F 17/30

(52) U.S. Cl. CPC G06T 7/0004; G06K 9/6267; G06F 17/30247; G06K 9/46; G06Q 40/08; G06Q 30/0278; G06K 2009/4666

(57) ABSTRACT

Methods for identifying things or parts of things, e.g., but not limited to, tires or parts of tires, so that responsibility for actions related to the thing or part may be determined; and things with identifier(s) according to the present invention. This abstract is provided to comply with the rules requiring an abstract which will allow a searcher or other reader to quickly ascertain the subject matter of the technical disclosure and is submitted with the understanding that it will not be used to interpret or limit the scope or meaning of the claims, 37 C.F.R. 1.72(b).

### RELATED APPLICATION

This application claims priority under the Patent Laws from pending U.S. Patent Application Ser. No. 61/960,138 filed Sep. 11, 2013, which application is incorporated fully herein for all purposes.

### BACKGROUND OF THE INVENTION

1. Field Of The Invention

The present invention is directed to identifying and tracking debris, such as tire parts, automobile parts and pieces of retread or recap tires; identifiers for such debris; methods for ticketing for such debris; methods for reimbursing for damage caused by such debris; and methods for reimbursing clean-up and collection efforts of such things.

The present invention is directed to identification and tracking systems for items, e.g., but not limited to, items that are part of or on a vehicle and which exit, separate from, break away from, or leave the vehicle; in certain aspects, to parts of a vehicle that are separated from the vehicle in use; to things carried in or on a vehicle that become separated in use, e.g., but not limited to, oil, fule, transmission fluid, water, trash, litter, debris, and cargo; to systems and methods for tracking such parts or things and providing for financial responsibility by a BUMOSS (buyer, user, maker, owner, supplier, and/or seller)(also collectively “BUMSS” which includes any and all “associated parties” as discussed herein) for detection, collection, clean up, return, disposal, related to such a thing and/or for damages, injury, and/or death caused by such a part or thing; and, in certain particular aspects, to systems and methods for identifying and tracking parts of tires, particularly recapped tires and retreaded tires. “Vehicles” can include, but are not limited to, automobiles, bicycles, motorcycles, airplanes, helicopters, RVs, trucks, trailers, boats, drones, airships, balloons, missiles, ammunition, ordnance, military vehicles, locomotives, and rail cars.

The present invention is directed to identifying and tracking parts of an item, the item having a plurality of identifiers, each part of the item having at least one or a plurality of identifiers.

2. Description of Related Art

The prior art discloses a wide variety of identifiers, identifiers for items and things, identifiers for vehicle parts, and a wide variety of methods for detecting things and for cleaning roadways and collecting debris.

### SUMMARY OF THE PRESENT INVENTION

The present invention, in certain aspects, discloses an identification system for an item, e.g., a vehicle part (such as, but not limited to, a truck, drone, helicopter, an automobile, RV, trailer, boat, airplane, vehicle, drone, truck, trailer, engine, exhaust system part, automobile, tank, helicopter, glider, submarine, apparatus, device, computer, phone, piece of furniture, motorcycle, tire, wheel, bicycle, electronic instrument, light, window, building, and human or animal body part, a tire part, body part, engine part, or ornamental part or piece for any of these. In certain aspects, such a system includes a plurality of spaced-apart identifiers on an item with a sufficient number of identifiers present so that a part of an item less than the whole item has or is likely to have at least one of the plurality of identifiers therein and/or thereon, the part in one aspect sufficiently large to injure a person or a thing. Thus, for example, if a six-inch long and two-inch wide piece of a retread tire or a four-inch piece of a muffler is found on a roadway, there will be at least one identifier—and perhaps more than one identifiers—on the piece. In one aspect, a tire has sufficient identifiers so that each piece with an area of two inches square of the tire has at least one identifier. In one aspect, a tire has sufficient identifiers so that each piece with an area of four inches square of the tire has at least one identifier. In one aspect, a tire has sufficient identifiers so that each piece with an area of eight inches square of the tire has at least one identifier. In one aspect, a tire has sufficient identifiers so that each piece with an area of a square foot of the tire has at least one identifier. In one aspect, a tire has sufficient identifiers so that each piece with an area of two square feet of the tire has at least one identifier. In one aspect, an item has sufficient identifiers so that each piece with an area of two inches square of the item has at least one identifier. In one aspect, an item has sufficient identifiers so that each piece with an area of four inches square of the item has at least one identifier. In one aspect, an item has sufficient identifiers so that each piece with an area of eight inches square of the item has at least one identifier. In one aspect, an item has sufficient identifiers so that each piece with an area of a square foot of the item has at least one identifier. In one aspect, an item has sufficient identifiers so that each piece with an area of two square feet of the item has at least one identifier. In one aspect, an item or a tire has sufficient identifiers so that each piece with a volume of at least six ounces, twelve ounces, a pint, a quart, a gallon, or twenty gallons or more, or at least fifty gallons has at least one identifier.

An item with identifier(s) may be an amount of a fluid, a liquid or a gas.

In other aspects, the item or part thereof that is located and, optionally, retrieved is: garbage; granular material such as sand, pebbles, grain, gravel, or dirt; rocks; building materials; crops such as grain or hay; lumber; pipe; logs or parts of trees or shrubs; tools; and/or equipment.

In certain aspects, the item or part thereof is on or near a roadway; but it is within the scope of the present invention for the methods herein to apply to any item or part located anywhere, e.g. but not limited to, in a factory, in a residential area, in a playground, in an arena, in a wilderness area, in a desert, in a work area, in the earth, in a wellbore, adjacent a wellbore, or in the earth spaced-apart from or remote from a wellbore.

In certain embodiments, the present invention provides an item as any item described and disclosed herein, the item in certain aspects optionally with a system thereon for accessing an identifier or identifiers of the item according to the present invention and for storing in the system information from the identifier(s); in one aspect, the item is a thing that causes or is involved in damage to the automobile and/or injury to an occupant of the automobile and/or the death of an occupant of the automobile or the injury or death of anyone due to, related to, or caused by—directly or indirectly (e.g., in an effort to avoid a thing or part of a thing) the thing or part of the thing; in certain aspects, the item being one of a vehicle, boat, drone, truck trailer, RV, engine, exhaust system part, automobile, tank, helicopter, plane, submarine, apparatus, device, computer, phone, piece of furniture, motorcycle, tire, wheel, bicycle, electronic instrument, light, window, building, and human or animal body part

It is within the scope of the present invention to use any suitable known identifier or combination of different known identifiers on items. Any suitable known passive or active identifier may be used, including, but not limited to, identifying words, numerals, symbols, patterns, codes, colors, and indicia, as well as visual, electronic, and chemical identifiers. Any suitable passive or active trackable and/or interrogatable and/or activatable/readable identifiers may be used, including visual, optic, electric, electronic, chemical, McNano, tags, radio tags, RFID tags, SAW tags, chips, Nanotags, and micro identifiers; and, without limitation, such as those disclosed in: U.S. applications Ser. Nos. 13/373,283 filed Nov. 9, 2011; Ser. No. 12/133,984 filed Jun. 5, 2008; Ser. No. 11/913,661 filed May 5, 2006; Ser. No. 13/374,573 filed Jan. 3, 2012; Ser. No. 13/986,466 filed May 6, 2013; Ser. No. 12/604,310 filed Oct. 22, 2009; Ser. No. 12/501,909 filed Jul. 13, 2009; Ser. No. 12/498,689 filed Jul. 7, 2009; Ser. No. 12/497,193 filed Jul. 2, U.S. patent application Ser. No. 11/913,661 published Jan. 29, 2009, Pub. No. 2009/0027280 A1; and those disclosed in U.S. Pat. Nos. 7,874,250; 7,629,604; and those disclosed in PCT Application Int'l Application No. PCT/US2012/000105—all of which applications and patents are incorporated fully herein for all purposes.

An identifier or identifiers may be added to, placed on, imprinted on, embossed on, engraved on, adhered to, injected into, connected to, placed in, embedded in, or mixed in with, an item or part of an item at any point in the item's manufacture, assembly, processing, painting, covering, finishing, treatment, shipment, or use.

In certain aspects an item that has distinct parts or areas has both a plurality of primary identifiers in every part or area and also secondary identifiers for specifically identifying each distinct part or area. In one aspect such an item has parts that are together and which come apart without breaking. In other aspects, the item when broken has distinct parts, each with at least one or a plurality of the primary identifiers and, optionally, with the secondary identifiers.

A plurality of identifiers is used in certain items according to the present invention in sufficient number that any appreciable part or area that may be separated from the item and/or broken off from the item has at least one, and possibly more than one, of the identifiers. In this way, for example, a part of a tire that separates from a tire (the tire initially with a plurality of identifiers in and/or on the tire) will have at least one or a plurality of identifiers; or a part of a vehicle, e.g., a piece of an exhaust pipe, will have at least one and possibly a plurality of identifiers associated with the vehicle. In certain aspects, the number of identifiers and the spacing of identifiers, as well as the use of them in, on, or both in and on the item, are chosen so that a part of anticipated size will have at least one or more than one of the identifiers; and, with items with distinct parts that are likely to be separated from the item, such a part may have a part-specific identifier in addition to or instead of identifier(s) that identify the item.

An identifier may include information disclosing the nature of the original item (e.g., but not limited to, when a small piece of metal or plastic is found and it is not readily apparent what item it is a part of); the manufacturer of the original item; the seller of the original item; the buyer of the item; the user of the original item (including, but not limited to, a driver of a truck and a trucking line; the material of the original item and/or the material of the part; and/or the age of the item.

In certain methods according to the present invention, an item or part of an item is collected, discovered, picked up, or swept up, and then an identifying apparatus accesses, reads, scans, interrogates, inspects, and/or activates identifier(s) in or on the item or part thereof, thus providing information about the item or part thereof. In certain aspects, this information includes information about a party, entity, person, or company in some way associated with the item or part thereof (e.g., the identity of a maker, shipper, seller, and/or user). Such information may then, optionally, be used to contact the party, etc. for a variety of purposes: e.g., to come and retrieve and remove the item or part thereof; to take the item or part to a disposal area or apparatus; to invoice a party etc. for further action (disposal, shipment, etc. of the item or part and/or billing for initial recover and collection of the item or part, e.g., a part of a muffler or a part of a tire from a roadway. In one aspect, the information gleaned from identifier(s) is collected in a database and when, for a particular entity, a number of items, a number of parts, a threshold amount of parts, or an aggregated weight of collected parts is reached or exceeded, then an invoice, citation, and/or ticket (e.g., but not limited to, a ticket for littering) is issued to the entity.

Any suitable known machine, apparatus, device, equipment, or system may be used to find, collect, pick up, and/or retrieve an item or a part of an item; e.g., but not limited to, street sweepers, mowers, trucks, tractors, and trailers. Either personnel associated with the apparatus, etc., has an identifying apparatus that locates, accesses, reads, scans, interrogates, inspects, and/or activates identifier(s) in or on the item or part thereof, thus providing information about the item or part thereof; or such an apparatus, etc., is on or in the machine, etc., that an identifying apparatus locates, accesses, reads, scans, interrogates, inspects, and/or activates identifier(s) in or on the item or part thereof, thus providing information about the item or part thereof. Any discovered, revealed, accessed, and/or retrieved information may be stored in the identifying apparatus and/or transmitted to other apparatuses, devices, equipment, and/or systems nearby and/or remote. Any identifying machine may have positioning capability for noting and/or locating an item or part thereof, and or any machine etc., using the global positioning system so that the location of a machine etc. is known and the location of discovery, collection, retrieval, or encounter with an item or part thereof is known and is recorded, and, if desired, transmitted to other personnel and/or systems. In certain aspects, a metal detector is or is include in or with an identifying apparatus. Any known metal detector may be used including any known electronic devices, computers, chips and PLCs used with them.

In one case, a part of an item is located and retrieved, its identity is ascertained and the identity of its last user, the location position (GPS) of the retrieval is noted, and an invoice is sent to the last user (and/or other involved entities) for the retrieval and/or for disposal of the item. Also, it is within the scope of the present invention for information about the item and/or its retrieval and collection to be sent to government agencies (local, state, federal, national), insurance companies associated with any entity involved, and to the manufacturer or the item.

In one particular aspect, a system is provided for receiving information about items that are located and identified (and, in some cases collected and/or disposed of) and each item's identity is stored in a storage medium. A processor aggregates both the number of items for each particular entity and/or aggregates a total measured amount of material (e.g., weight and/or size) of items for each entity and stores the totals. Upon reaching a predetermined number and/or a predetermined amount and/or a predetermined volume or area, a notice and/or invoice and/or ticket is sent to an entity or to entities associated with the item for the locations, collection, identifying, storage and/or disposal of the item. Optionally such an invoice, etc. is sent periodically, e.g., each week or each month, instead of or in addition to the notices etc. sent when a threshold is met.

In certain particular aspects, a method is provided in which an item is located by a person with a device such as, but not limited to a smartphone (or any suitable computer or computer device), who scans the item with the phone, and transmits the retrieved information from item identifier(s) to a remote entity that then processes the information, stores it, and/or invoices an entity associated with the item. Optionally the person's phone does some or all of these tasks with a computer application either on the phone or available in the Cloud. Such a person can be paid or rewarded for doing this.

Information retrieved from an item by any method herein may be used as the basis for a variety of alarms, notifications, and alerts, e.g., for drivers on roadways, for law enforcement personnel, and road maintenance agencies and personnel. An alert about an item in or near a roadway can be provided by any known system for providing such information, such as, but not limited to, the systems that presently provide information to drivers regarding road conditions, road closures, detours, elder alerts, amber alerts, escaped prisoners, and weather conditions. The alerts can be provided according to the present invention on screens over or adjacent roadways, on designated radio stations, and/or via computer apps on individual computer devices, e.g., laptop computers, netbooks, tablet computers, iPads, iPhones, cellphones, and smartphones.

In certain aspects, the present invention provides identifying apparatus on a machine, e.g., a car, road maintenance equipment, road paving equipment, or a mower, that hits an item or part thereof or that is hit by an item or a part thereof. The identifying apparatus identifies the item or part and, inter alia, identifies the user of the item so that the user (or any other associated entity or entities) can be held responsible for damage to the machine and/or to a person. Similarly, this method applies to any vehicle, plane, boat, etc.

In certain aspects, the present invention provides an insurance product whose price is discounted or reduced, and/or a rebate is provided to an insured if the insured places identifier(s) on its equipment and/or uses identified equipment, vehicles, systems, machines, tools, etc. For example, an automobile insurance policy is provider at a cheaper rate for a driver whose automobile and its parts has identifiers according to the present invention; or a trucking company's insurance policies for its vehicles are reduced in price if the vehicles have identifiers according to the present invention. Optionally, an insurance company can require this of all of its insureds.

Similarly, government entities can either require identifiers be used according to the present invention, or government taxes and/or fees can be reduced for those entities who do use the identifiers.

The present invention, in certain aspects, discloses systems and methods for identifying and tracking the parts of a vehicle and/or items or things (collectively “items”) carried in, on or by a vehicle. These parts or things have or bear in them or on them suitable identifier(s) for identification, tracking, and further steps and processing according to the present invention. This identification includes, in certain aspects, one or some of (or all of) the following about and/or related to the item: the buyer of the item, its user, its maker, owner, supplier(s) of parts for the item, and/or seller (collectively “BUMOSS”).

Upon identification of a part or item, possible actions according to methods of the present invention include: recordation of information in any suitable computer or system, on the vehicle, on another vehicle, on or near a roadway, and/or in a computer or system remote from the location of the part or item; recordation of time of part or item separation and identity of the source vehicle; notification of government entities about the part or item and its separation from a vehicle; notification to person(s) in other vehicles about the separation of the part or item, e.g., but not limited to, signals, alerts, warnings, alarms, and/or messages to a system, phone, or computer in another vehicle; preparation of an invoice or other payment instrument or notice for one or all of the BUMOSS to pay for actions, events, and occurrences related to and/or caused by the item, including, but not limited to, cost of collection of the parts or items from a roadway, median, shoulder, or other location; cost of clean up, damage to roads, damage to vehicles, damage to roadworking and/or mowing equipment, damage to persons, personal injuries, and death; notification to insurance companies that provide insurance for one or more of the BUMOSS; notices and/or alerts to law enforcement personnel near or ahead of any vehicle from which a part or item has been separated; notice to one or some of the BUMSS of a fine or fee by a governmental entity or agency due to the separation of the part or item from the vehicle; and/or a signal, alert or warning provided on roadway sign systems of the location of the part or item and/or of the identity and/or location of the vehicle from which it was separated.

Any identification according to the present invention can be provided by: a system in or on part of a roadway such as, but not limited to, in or on a roadway itself (e.g., concrete, asphalt, etc.), a barrier, a median, a light post, a sign, a signpost, a curb, a wall, lane marker, and reflector; a system in or on a vehicle, including a vehicle from which a part or item is separated and/or another vehicle; a roadworking vehicle or equipment, such as, but not limited to, a mower, street sweeper, or paving equipment; and/or a system in a surveillance vehicle on or above the roadway. Any such system in or on a vehicle can identify, track, and provide further functions according to the present invention for a part or item that is passed or one that is hit or that impacts the other vehicle. Notice of a part or item separated from a vehicle can be provided by a system on the vehicle itself and such a system can also provide any of the other functions and notices, etc. of methods according to the present invention.

In certain particular aspects, systems and methods according to the present invention provide for shutting down a vehicle from which a part or item is separated, including in the event that such a vehicle is not rendered inoperable or immobile by such separation.

The identification for identifying a part or item in methods according to the present invention may be any suitable known identifier, e.g., but not limited to, suitable indicia, code, symbol, tag, label, pattern, chemistry, metallurgy, device, McNano device, NanoTag, SAW tag, RFID tag or device, or information. The identifier can be active or passive, visually viewable and/or scannable and/or electronically activatable and/or interrogatable; including, but not limited to, those in the patent applications and the patents listed above by serial number or patent number. For any part or item, a suitable number of individual identifiers are used so that any part or item, or any piece of such a part or item has at least one identifier so that identification is possible. For example, a retread portion of a tire may have multiple spaced-apart identifiers, e.g., but not limited to, one identifier for every square inch of such retread portion or for every four or twelve square inches of such portion.

In certain particular aspects, a part or item separated from a vehicle is something that is intentionally taken from the vehicle and/or is stolen. Also, the present invention provides systems and methods for the return of parts and/or items to an owner when the part or item is separated from a vehicle, e.g., but not limited to parts such as hubs, hubcaps, and radiator caps and cargo items that are separated from a carrier vehicle.

In certain aspects, the present invention provides systems and methods which record, store, and then total for each BUMOSS: number of items and/or parts related to a particular one of the BUMOSS; the size of such parts and/or items; the weight of them; the cost of collection of them; the cost of disposal of them; and/or the locations of them after separation from a vehicle.

The present invention provides methods for discounting an insurance policy or a vehicle and/or for a BUMOSS based on one or some of: vehicles provided with parts identifiers; cargo provided with identifiers; and/or record for parts and/or items separation from vehicles. The present invention provides methods for insuring a vehicle that require that a BUMOSS provides a vehicle and/or a part and/or an item with identifiers and/or with systems for sensing parts and/or items separation from vehicles.

In certain particular aspects, the present invention provides systems and methods for the real time monitoring of tires in a vehicle and notification to a person in the vehicle if a part of a tire separates from the vehicle, e.g. a piece of a retread portion of a tire. Monitoring of tires, particularly retreads, can also be provided by systems not on or in a vehicle, but separated therefrom, e.g., by a system at a toll booth, at a truck weigh station, or a portable system used by law enforcement personnel.

Accordingly, the present invention includes features and advantages which are believed to enable it to advance identification technology, item detection and retrieval technology, and technologies related to tire and retread identification and retrieval. Characteristics and advantages of the present invention described above and additional features and benefits will be readily apparent to those skilled in the art upon consideration of the following description of preferred embodiments and referring to the accompanying drawings.

Certain embodiments of this invention are not limited to any particular individual feature disclosed here, but include combinations of them distinguished from the prior art in their structures, functions, and/or results achieved.

Features of the invention have been broadly described so that the detailed descriptions of embodiments preferred at the time of filing for this patent that follow may be better understood, and in order that the contributions of this invention to the arts may be better appreciated.

It is, therefore, an object of at least certain embodiments of the present invention to provide the embodiments and aspects listed above, those described below, and:

New, useful, unique, efficient, nonobvious identifiable things and methods for their identification;

Such things with a sufficient number of identifiers that a part of the thing has at least one or multiple identifiers when the part is separated from or breaks off from the thing; and

New, useful, unique, efficient, nonobvious for assigning responsibility for things and parts thereof which enter onto, fall onto, are ejected onto, or separate from a vehicle and become positioned on a roadway or nearby, in certain aspects, requiring financial responsibility by any or all of the BUMSS associated with a thing.

The present invention recognizes and addresses the problems and needs in this area and provides a solution to those problems and a satisfactory meeting of those needs in its various possible embodiments and equivalents thereof. To one of skill in this art who has the benefits of this invention's realizations, teachings, disclosures, and suggestions, various purposes and advantages will be appreciated from the following description of certain preferred embodiments, given for the purpose of disclosure, when taken in conjunction with the accompanying drawings. The detail in these descriptions is not intended to thwart this patent's object to claim this invention no matter how others may later attempt to disguise it by variations in form, changes, or additions of further improvements.

The Abstract that is part hereof is to enable the U.S. Patent and Trademark Office and the public generally, and scientists, engineers, researchers, and practitioners in the art who are not familiar with patent terms or legal terms of phraseology to determine quickly, from a cursory inspection or review, the nature and general area of the disclosure of this invention. The Abstract is neither intended to define the invention, which is done by the claims, nor is it intended to be limiting of the scope of the invention in any way.

It will be understood that the various embodiments of the present invention may include one, some, or all of the disclosed, described, and/or enumerated improvements and/or technical advantages and/or elements in claims to this invention.

Certain aspects, certain embodiments, and certain preferable features of the invention are set out herein. Any combination of aspects or features shown in any aspect or embodiment can be used except where such aspects or features are mutually exclusive. Any combination of one or some aspects and/or of one or some features described above, below, in independent claims, or in dependent claims can be used except where such aspects and/or features are mutually exclusive. It should be understood that the appended drawings and description herein are of certain embodiments and are not intended to limit the invention or the appended claims. On the contrary, the intention is to cover all modifications, equivalents and alternatives falling within the spirit and scope of the invention as defined by the appended claims. In showing and describing these embodiments, like or identical reference numerals are used to identify common or similar elements. The figures are not necessarily to scale and certain features and certain views of the figures may be shown exaggerated in scale or in schematic in the interest of clarity and conciseness. As used herein and throughout all the various portions (and headings) of this patent, the terms “invention”, “present invention” and variations thereof mean one or more embodiments, and are not intended to mean the claimed invention of any particular appended claim(s) or all of the appended claims. Accordingly, the subject or topic of each such reference is not automatically or necessarily part of, or required by, any particular claim(s) merely because of such reference. So long as they are not mutually exclusive or contradictory any aspect or feature or combination of aspects or features of any embodiment disclosed herein may be used in any other embodiment disclosed herein. The drawing figures present the embodiments preferred at the time of filing for this patent.

### BRIEF DESCRIPTION OF THE SEVERAL VIEWS OF THE DRAWINGS

A more particular description of embodiments of the invention briefly summarized above may be had by references to the embodiments which are shown in the drawings which form a part of this specification. These drawings illustrate embodiments preferred at the time of filing for this patent and are not to be used to improperly limit the scope of the invention which may have other equally effective or legally equivalent embodiments.

FIG. 1A is a perspective view of an item according to the present invention.

FIG. 1B is a perspective view of the item of Fig. 1A broken into or separated into two parts.

FIG. 1C is a perspective view of an item according to the present invention.

FIG. 1D is a perspective view of the item of FIG. 1C broken into or separated into two parts.

FIG. 1E is a perspective view of an item according to the present invention.

FIG. 1F is a perspective view of the item of FIG. 1C broken into or separated into two parts.

FIG. 1G is a perspective view of an item according to the present invention.

FIG. 1H is a perspective view of the item of FIG. 1C broken separated into three parts.

FIG. 2 is a partial crosssection view of a tire according to the present invention.

FIG. 2A is a side view of a tire according to the present invention.

FIG. 2B is a section view along line 2B-2B of FIG. 2A.

FIG. 2C is an enlargement of part of the tire as shown in FIG. 2B.

FIG. 3A is a crosssection view of a tire (shown partially) according to the present invention.

FIG. 3B is a view of the tire of FIG. 3A broken into three pieces.

FIG. 3C is a crosssection view of a tire (shown partially) according to the present invention.

FIG. 3D is a crosssection view of part of the tire of FIG. 3C that has broken away from the tire of FIG. 3C.

FIG. 4 is a schematic view of systems according to the present invention.

FIG. 5A is a diagram of a method according to the present invention; and includes some steps implementable by a computer program according to the present invention for certain steps of a method according to the present invention.

FIG. 5B is a diagram of a method according to the present invention; and some steps implementable by a computer program.

FIG. 6 is a diagram of a method according to the present invention; and is, in one aspect, a block diagram of a computer program according to the present invention for certain steps of a method according to the present invention.

FIG. 7 is a diagram of a method according to the present invention; and is, in one aspect, a block diagram of a computer program according to the present invention for steps of a method according to the present invention.

FIG. 8 is a diagram of a method according to the present invention; and is, in one aspect, a block diagram of a computer program according to the present invention for steps of a method according to the present invention.

Any combination of one or some aspects and/or of one or some features described above, below, in independent claims, or in dependent claims can be used except where such aspects and/or features are mutually exclusive. It should be understood that the appended drawings and description herein are of certain embodiments and are not intended to limit the invention or the appended claims. On the contrary, the intention is to cover all modifications, equivalents and alternatives falling within the spirit and scope of the invention as defined by the appended claims. In showing and describing these embodiments, like or identical reference numerals are used to identify common or similar elements. The figures are not necessarily to scale and certain features and certain views of the figures may be shown exaggerated in scale or in schematic in the interest of clarity and conciseness. As used herein and throughout all the various portions (and headings) of this patent, the terms “invention”, “present invention” and variations thereof mean one or more embodiments, and are not intended to mean the claimed invention of any particular appended claim(s) or all of the appended claims. Accordingly, the subject or topic of each such reference is not automatically or necessarily part of, or required by, any particular claim(s) merely because of such reference. So long as they are not mutually exclusive or contradictory any aspect or feature or combination of aspects or features of any embodiment disclosed herein may be used in any other embodiment disclosed herein. The drawing figures present the embodiments preferred at the time of filing for this patent.

### DETAILED DESCRIPTION OF CERTAIN EMBODIMENTS OF THE INVENTION

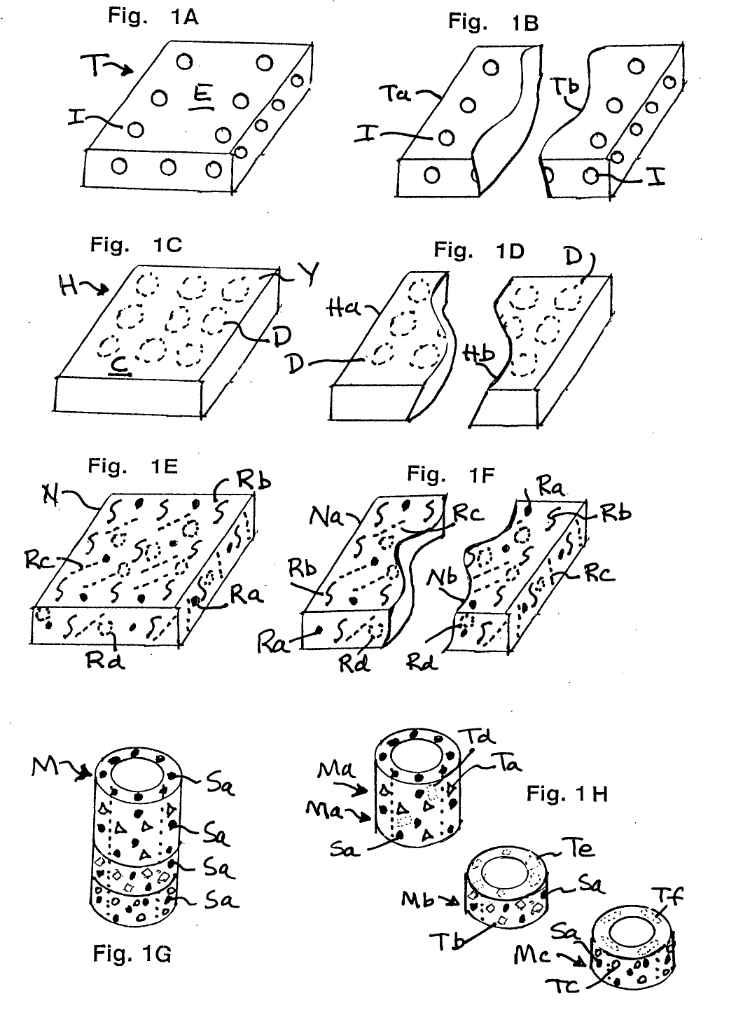

FIG. 1A shows a thing T (shown schematically and in general) with an exterior surface E. A plurality of identifiers I are on the surface E. FIG. 1B shows the thing T in two pieces, Ta and Tb. Each piece Ta and Tb has a plurality of identifiers I which make it possible to identify the original thing T of which the pieces Ta and Tb are pieces. In one aspect, the thing T is a tire; and, in one particular aspect, the tire is a retread or recap tire. As is true of the other embodiments of the present invention, the use of multiple identifiers applies to a thing that ends up in multiple pieces, e.g. two, three, four, or more pieces.

FIG. 1C shows a thing H (shown schematically and in general) which has a body Y with an exterior surface C. A plurality of identifiers D are in the body Y. FIG. 1D shows the thing H in two pieces, Ha and Hb. Each piece Ha and Hb has a plurality of identifiers D which make it possible to identify the original thing H of which the pieces Ha and Hb are pieces. In one aspect, the thing H is a tire; and, in one particular aspect, the tire is a retread or recap tire.

FIG. 1E shows a thing N (shown schematically and in general) which has a body P with an exterior surface J. A plurality of identifiers are in and on the body P: on the body P are identifiers Ra, solid dots, and Rb, squiggly lines; and in the body are identifiers Rc, dotted lines, and Rd, dotted circles. FIG. 1F shows the thing N in two pieces, Na and Nb. Each piece Na and Nb has a plurality of all four types of identifiers R which make it possible to identify the original thing N of which the pieces Na and Nb are pieces. In one aspect, the thing N is a tire; and, in one particular aspect, the tire is a retread or recap tire. The use of multiple identifiers makes it possible to thwart efforts of others to counterfeit the thing being identified; and, optionally—as is true for any embodiment herein—the identifiers may be of different kinds, e.g, but not limited to, both passive and active identifiers, and/or both visually detectable identifiers and identifiers not visually detectable.

It is within the scope of the present invention to provide identifiers for an item which is made of interconnected parts which, either in use, manufacture, or for repair or maintenance, are disconnected or disassemble. Each of such parts may have primary identifier(s) in each part and secondary identifier(s) in each part.

FIG. 1G shows an item M schematically, e.g., but not limited to, a device, a piece of equipment, a structural member, or a machine, which has multiple parts Ma, Mb, and Mc. As shown in FIG. 1H, these parts can become or can be disconnected from each other. Every part has multiple primary identifiers Sa (shown as solid dots). The part Ma has secondary identifiers Ta thereon and secondary identifiers Tb therein; the part Mb has secondary identifiers Tb thereon and secondary identifiers Te therein; and the part Mc has secondary identifiers Tc thereon and secondary identifirs Tf therein. The secondary identifiers, inter alia, identify the specific part. It is within the scope of the present invention for any of these identifers to be on or in or both on and in the particular part.

When tires become worn, they can be restored with new tread. Both automobile, small truck and large truck tires can be retreaded as part of a routine tire-management program. The carcass of a truck tire is expected to last several hundred thousand miles and be amenable to having a new tread adhered to it several times. New truck tires are quite expensive and are therefore bought with the expectation that their high initial costs are offset by the long service life of the carcass and the low comparative cost of retreading.

A variety of procedures and different types of equipment are available for use in recapping or retreading pneumatic tires. One of the first steps in retreading a worn tire is to remove existing tread material from the tire carcass by a sanding procedure known as buffing. Next a layer of what is known as “cushion gum” is applied to the carcass. This layer of extruded, uncured rubber may be stitched or adhesively bonded to the carcass. Next, a tread layer is applied atop the layer of cushion gum. In the cold recapping process, the tread layer is cured rubber, and has a tread pattern already impressed in its outer surface. The tire is then placed in an autoclave, and heated under pressure for an appropriate time to induce curing of the gum layer, and binding of the gum layer to the inner or sole side of the tread layer and the carcass. The term “cure” refers to the formation of cross-links between the elastomer molecules in the rubber compound. It is further noted that there are various methods of bonding the tread layer to the carcass such as the use of adhesives, bonding agents, cushion gums, etc., and that all of the methods known in the art are included when referring to the term “bonding interface”.

A common problem with tires, including retreads, is that as the tire wears, the traction-providing elements also wear, until eventually the elements are substantially worn away. The result can be a significant reduction in traction for the worn tire. Efforts have been made to develop a tread layer that has tread elements cut into the sole side (the side opposite the tread side) of the tread layer. The term “tread elements” refers to sipes, lateral grooves, and/or longitudinal grooves or any other void formed in the tread. The tread elements molded into the sole side of the tread layer appear as the tire wears, giving improved worn traction over the life of the retread and allowing the tire to be removed from service later in life.

According to the present invention, any part of a tire and any part of a retread or recap tire may have a plurality of identifiers (any disclosed herein). This includes, inter alia, the gum or adhesive layer that attaches a new tread to an old tire. Primary identifiers may be used in some or every part of the tire and secondary identifiers may be used for a specific part of a tire, e.g., but not limited to, a bead, sidewall, carcass, shoulder, crown, and a retread tread part.

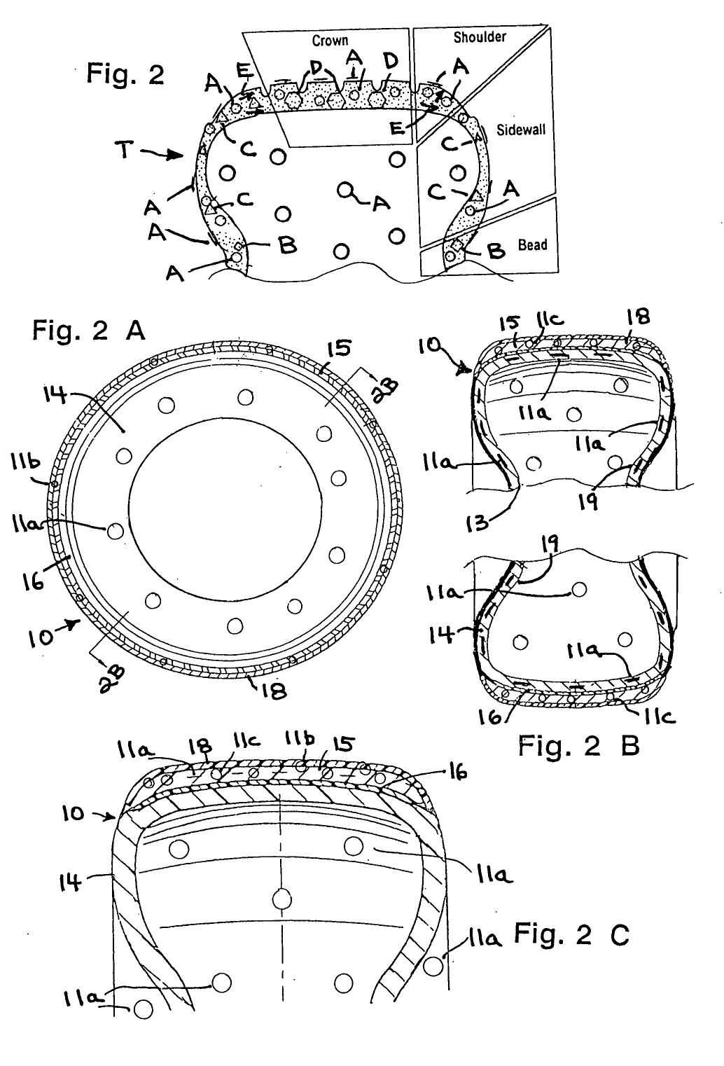

FIG. 2 shows a tire T according to the present invention, (shown partially), has sidewalls, a bead, shoulders, and a crown. Primary identifiers indicated by circles (and lines for showing those on the tire's exterior) identify this particular tire and may have any of the information associated with this tire. Secondary identifiers indicate a specific part of the tire—squares B, the bead; triangles C, the sidewalls; heaxagons D, the crown; and arrows E, the shoulders.

FIGS. 2A and 2B show a tire 10 according to the present invention with a tire carcass 14, an intermediate gum layer 16, and a tread strip 15. Optionally, the tread strip includes a second layer 18. The tire carcass 14 includes integral sidewalls 19 that extend radially inwardly until each one forms a circumferential bead 13.

Primary identifiers 11a are on the interior of the carcass 14 and may, optionally be on its exterior. They are also within the carcass 14. Secondary identifiers 11b are between layers 15 and 18; and secondary identifiers 11b are in the layer 15.

For example, if a piece of the layer 15 with at least one secondary identifier 11b separates from the tire 10, the information associated with the identifier 11b may be accessed and/or obtained—and this will include information indicating that the piece is from a layer like the layer 15. Accessing and/or interrogating a primary identifier 11a in the piece of the layer 15 will provide the identifying information for the tire 10.

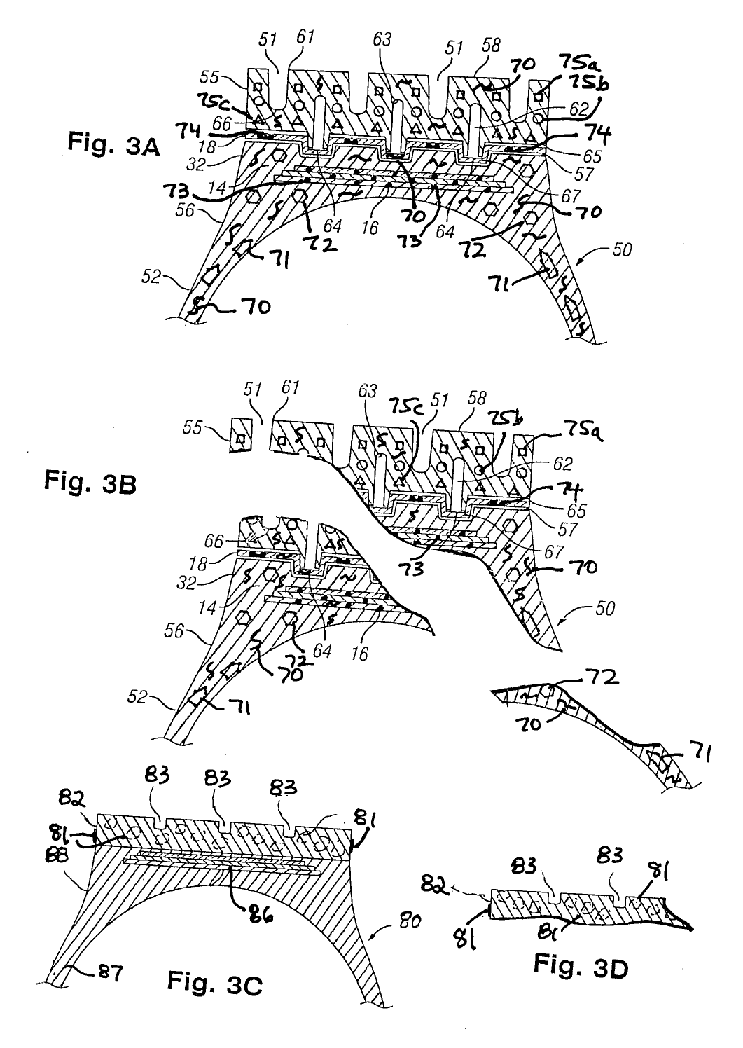

FIG. 3A shows a tire 50 according to the present invention which includes a base portion 52 and a precured tread band 55 that is bonded to the base portion 52 with a cushion gum layer 18. The base portion 52 of the tire includes a tire carcass 56 having a reinforcement package 16 in a crown section 14, the crown section 14 having been buffed or otherwise worked to provide a prepared bonding surface 57 to which the precured tread band 55 can be bonded with cushion gum 18.

The precured tread band 55 has a primary groove 51 having a top 61 open to a ground contacting front face 58 of the tread band 55 and further has a secondary groove 62 having a top 63 closed to the ground contacting front face 58 of the tread band 55 and a groove bottom portion 64 that extends below a back face 65 of the tread band 55. The back face 65 of the tread band 55 is bonded to the prepared bonding surface 57 of the retread tire 50 during the retreading process. Optionally, the groove top 63 of the secondary groove 62 is higher than a groove bottom 66 of the primary groove 51 so that the secondary groove 62 is exposed to the ground contacting front face 58 prior to the disappearance by wear of the primary groove 51.

The tread band 55 is aligned onto the prepared bonding surface 57 of the base portion 52 of the tire so that the groove bottom portion 64 of the secondary tread groove 62 aligns with and is embedded within a base groove 67 that was not buffed away or was otherwise provided. The back face 65 of the tread band 55 is bonded to the prepared bonding surface 57 of the base portion 52 of the tire 50. A tire like the tire 50—but without an appreciation or recognition of the teachings of the present invention—is disclosed in U.S. Patent Application Publication No. 20120097300, incorporated fully herein for all purposes.

It is within the scope of the present invention to use primary identifiers 70—shown as “S” squiggly lines—throughout the tire 50 in every part thereof. Each specific part of the tire may have its own secondary identifiers; e.g. base portion, identifiers 71; tire carcass, identifiers 72; reinforcement package, identifiers 73; and cushion gum, identifiers 74.

The tread band 55 may have primary identifiers (not shown) for identifying the tire 50; and, optionally, the tread band 55 may have a plurality of different identifiers at different depths of the band to indicate how much of the band is worn and how much of the band is remaining. For example, the band 55 is shown with identifiers 75 a nearest the surface, identifiers 75b at a depth lower than the identifiers 75a, and identifiers 75c at a depth lowest within the band 55. Such wear/depth identifiers may be used in any tire, including in the tread of new tires, and the identifiers may be passive or active and are, on one aspect, identifiers of such a size and, optionally, of such a color and/or shape that they are easily visually locatable and identifiable.

FIG. 3B illustrates the tire 50 broken, separated, or torn into three pieces with each part containing primary and secondary identifiers. Thus if, for example the smallest part is recovered on or near a roadway, its identifiers' information may be retrieved and any of the possible actions with respect to those associated with the tire may be taken, e.g., but not limited to, giving a littering ticket to the user of the tire and/or an invoice for the cost of collection and identification. The same is true for the other pieces of the tire shown in FIG. 3B.

FIG. 3C shows a tire 80 (shown partially) with a base 87, a reinforcement package 86, and a tread 82 with grooves 83. A plurality of identifiers 81 are in and on the tread 82. A piece of the tread 82, shown in FIG. 3D, has a plurality of the identifiers 81 therein and thereon.

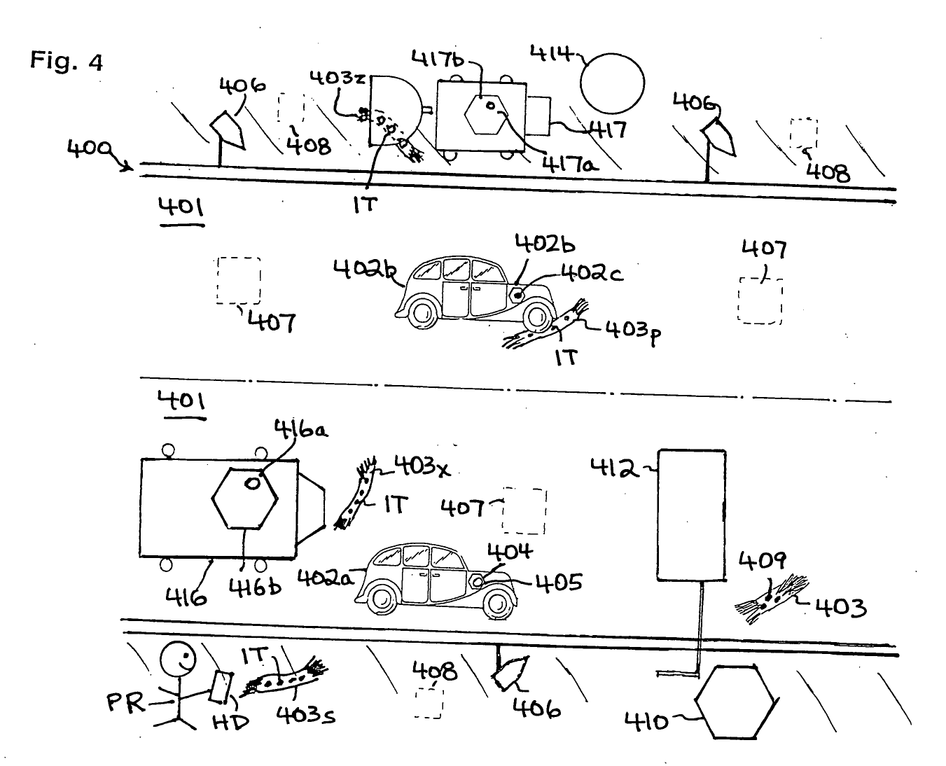

FIG. 4 illustrates a variety of systems and methods according to the present invention that deal with parts of tires that have separated from a whole tire on a vehicle. A roadway 400 includes lane(s) 401 for vehicles such as automobiles 402a and 402b. In one method according to the present invention, as the automobile 402a progresses down the roadway 400, a piece 403 of a tire has one or a plurality of identifiers 409 which is sensed or detected by a sensing device or a detector (of course, the piece 403a may be anything from another vehicle, e.g., a part thereof or something carried by another vehicle). For example, a system 404 on the automobile 402a can have sensing equipment 405 which senses the piece 403; a camera 406 adjacent or over the roadway can detect the piece 403; a sensing device 416a on a collection vehicle 416; a sensing device 417a of a mowing vehicle 417; a sensing device 407 under a lane 401 can sense the piece 403; and/or a sensing device 408 adjacent the roadway can sense the piece 403. The sensing/detection of the piece 403 may be simply visual and/or it may be due to activation and/or interrogation of one or more of identifiers 409 in or on the piece 403. “Sensing device” includes any suitable known device for sensing and/or detecting a thing and includes, without limitation, any known device or equipment for sensing or detecting a thing along with suitable and/or required computer equipment, devices, components; and parts and associated software and hardware.

Other pieces shown in FIG. 4 have one identifier IT or a plurality of identifiers IT—which may be any identifier disclosed herein.

Following the detection of the presence of the piece 403 (and this includes detection with any device and in any way or method described herein by any person and/or device), the present invention includes a number of steps and/or actions for methods according to the present invention, including:

a signal, a communication, a notice, an alert, an email, a text message, a phone call, a voice message, a tweet, and/or warning (collectively “signal”) to a driver or other person in the automobile 402a regarding the presence, location, time and/or distance to encounter, and/or size of the piece 403 (or any other information provided by the identifiers 409); and/or such an alert or warning to any person or vehicle to whom this is of interest, including any other persons or person on the roadway, any other vehicles on the roadway, and any person or entity remote from the roadway

a signal, etc. about the piece 403 sent by any of the things that sense or detect the piece 403, or sent by a system in communication with any of the things that sense or detect, to a system 410 which can broadcast a notice, communication, or signal about the piece 403 and/or provide it to alert systems (e.g., visual and/or audio alert systems) such as a system 412 and to audio alert systems, e.g. via radio and/or cellphones and/or computer devices, to all nearby vehicles and persons and/or to remote persons and/or entities

a signal etc. to a user of a vehicle from which the piece 403 originated—and/or a notice to any other person or entity associated with the piece 403 (e.g., buyer, user, manufacturer, seller, lessor) associated with a tire from which it originated, or associated with a vehicle with the tire; e.g., such notice provided by a system 410, a system 414, and/or a handheld computer apparatus and/or cellphone

a signal etc. to a system with a processor and a database, the system for use in tracking and cataloging such pieces, e.g. a computerized system 414 (or e.g., a system 410 or 412), the system receiving, processing, and storing information about the piece 403, and, in one aspect, totaling amounts for an entity or entities associated with the piece 403, e.g., but not limited to, type(s) of piece(s) from the vehicle in question, number of pieces from the vehicle in question, total weight of pieces from the vehicle in question, total volume of pieces from the vehicle in question, and such totals for specific entities associated with the piece 403 such as tire retreading entities, and suppliers of parts for retreading

a signal, etc. to a collection entity and/or to a collection vehicle 416 about the piece 403 so that the piece 403 can be removed from the roadway

a signal, etc. to any other type of government entity, agency, and/or vehicle about the piece 403

A collection vehicle 416 may have its own dedicated system 416b which can detect, locate and identify a piece 403x like the piece 403; and the system 416b may communicate with any of the other systems described herein regarding the piece detected.

A mowing vehicle 417 may have its own dedicated system 417b which can detect, locate and identify a piece 403z like the piece 403, particularly a piece which the mower has encountered that has impacted and/or damaged the mowing equipment; and the system 417b may communicate with any of the other systems regarding the piece detected.

The automobile 402b may have its own dedicated system 402b which can detect, locate and identify a piece 403p like the piece 403, particularly a piece which the automobile has encountered that has impacted and/or damaged the automobile; and the system 402b may communicate with any of the other systems regarding the piece detected. The system 402b may include detection/sensing device 402c.

According to the present invention, a person PR with a handheld device HD may locate and/or identify a piece 403s (like the piece 403 or like any other piece in FIG. 4 or disclosed elsewhere herein). The handheld device HD may be any suitable computerized device, cellphone, computer, tablet computer, scanner, identifier interrogator, smartphone, laptop, notebook, or any small version of any sensing system disclosed herein—any of these, optionally, with a camera. As is true for any system herein and any of the systems used by the person PR, the system may provide the location of a detected piece. The handheld device HD may communicate with any other system disclosed herein. Any of these systems, including the handheld device HD, may be programmed to store information about all the pieces detected by the person PR and, optionally, pieces collected and carried away by the person PR.

In one aspect, such a person turns in retrieved pieces to a government entity or government representative and is paid by the number of pieces, the volume of pieces and/or the total weight of pieces. In one aspect, the government, in turn, may invoice, fine, penalize, and/or ticket a person or entity associated with the piece.

It is to be understood that the methods of the present invention include dealing with something other than a piece or part of a tire and that instead of the piece 403 of a tire, the piece 403 can be any part, cargo, debris, item, or thing encountered, on a roadway or anywhere, that is of interest to a person or entity, and, in certain aspects, parts, cargo, debris, items, or things that can cause damage to property and injury or death to person.

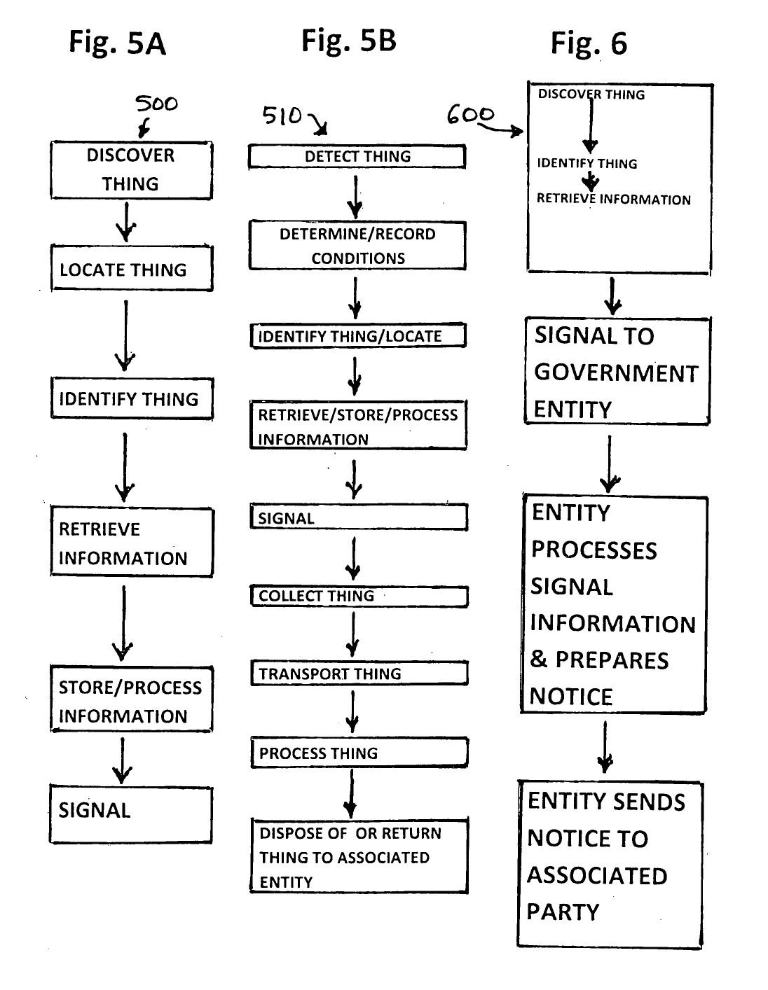

It is within the scope of the present invention to provide computer software and/or computer applications (“apps”) for facilitating and/or implementing any method of the present invention which can be, in whole or in part, thus implemented and/or facilitated. Any method herein according to the present invention can be effected and/or facilitated by a computer application, or “app,” that effects some, most, or all of the steps of the method and/or provides the necessary connections and/or communication between a person (or entity) and other components and apparatuses and devices used in a system that effects the method or step(s) thereof. For example, some (or all in some cases) of the steps of the methods described in FIGS. 5A-8 can be computer applications or “apps.” Routines executed to implement certain embodiments of the disclosure may be implemented as part of an operating system or a specific application or app, component, program, object, module, or sequence of instructions referred to as a “computer programs.” The computer programs or apps may be one or more instructions set at various times in various memory and storage devices in a computer, and that, when read and executed by one or more processing units or processors in a computer, cause the computer to perform operations to execute steps and/or elements involving the various aspects of the disclosure. Certain apps according to the present invention may be installed on a cellphone or smartphone.

Any software herein may be a computer application or “app.” This can be an app downloadable to a computer device, cellphone, computer, computer system, or smartphone. Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

One or more aspects of the invention may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing the invention in computer programming, and the invention should not be construed as limited to any one set of computer program instructions. Further, a skilled programmer enlightened with the teachings and suggestions of the present invention would be able to write such a computer program to implement an embodiment of the disclosed invention based on the appended diagrams and associated description in this text. Therefore, disclosure of a particular set of program instructions is not considered necessary for an adequate understanding of how to make and use the invention. Further, one or more aspects of the invention described herein may be performed by hardware, software, or a combination thereof, as may be embodied in one or more computing systems. Moreover, any reference to an act being performed by a computer should not be construed as being performed by a single computer as the act may be performed by more than one computer.

The present invention in certain aspects provides a computer program product including a tangible computer-readable medium having stored thereon computer-executable instructions which, when executed on a device, cause the device to implement a method—step or steps, element or elements—as described herein; and, in one aspect, wherein the tangible computer-readable medium is operatively associated with a network-connected server, and the computer-executable instructions are one or more files available for download via the network, and configured to install the computer-executable instructions on a user device. While the machine-readable medium or machine-readable storage medium may be in an exemplary embodiment a single medium, the terms “machine-readable medium” and “machine-readable storage medium” should be taken to include a single medium or multiple media (e.g., a centralized or distributed database, and/or associated caches and servers) that store the one or more sets of instructions. The terms “machine-readable medium” and “machine-readable storage medium” shall also be taken to include any medium that is capable of storing, encoding, or carrying a set of instructions for execution by the machine, and that cause the machine to perform any one or more of the methodologies of the presently disclosed methods, step(s), technique and/or innovation.

The various processes, systems, methods, devices, components and the like disclosed herein may be in the form of any appropriate combination of hardware, software, middleware, firmware and/or the like operable to carry out the various functionalities disclosed herein. For instance, such software, middleware and/or firmware may be implemented as one or more computer program products, i.e., one or more modules of computer program instructions encoded on a computer-readable medium for execution by one or more processors or processing modules, or to control the operation of, one or more data processing apparatuses. For example, an on-premises database, and an application bus, may be provided in such computer-readable medium and executed by a processor or the like. The computer-readable medium can be a machine-readable storage device (e.g., a memory module), a machine-readable storage substrate, a memory device, a composition of matter affecting a machine-readable propagated signal, or a combination of one or more of them. In addition to hardware, code that creates an execution environment for the computer program in question, e.g., code that constitutes processor firmware, a protocol stack, a database management system, an operating system, or a combination of one or more of them may be involved.

A computer program (also known as a program, software, software application, app, script, or code) used according to the present invention, e.g. to provide functionality described herein, may be written in any form of programming language, including compiled or interpreted languages, and may be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules sub-programs, or portions of code). A computer program can be deployed to be executed on one computer or on multiple computers that are located at one site or distributed across multiple sites and interconnected by an information flow network.

Block diagrams, processes, protocols and logic flows described in this specification can be performed by one or more programmable processors executing one or more computer programs to perform functions by operating on input data and generating output (e.g., but not limited to, certain blocks of the FIGS. 5A-8). The processes and logic flows can also be performed by, and apparatuses can also be implemented as, special purpose logic circuitry, e.g., an FPGA (field programmable gate array) or an ASIC (application-specific integrated circuit). Processors suitable for the execution of a computer program include, by way of example, both general and special purpose microprocessors, and any one or more processors of any kind of digital computer. In certain aspects, a processor will receive instructions and data from a read-only memory or a random access memory or both. In certain aspects, the elements of a computer are a processor for performing instructions and one or more memory devices for storing instructions and data. The techniques described herein may be implemented by a computer system configured to provide the functionality described.

Certain embodiments of methods of the present invention may be described herein in terms of functional block components and various processing steps. It should be appreciated that such functional blocks may be realized by any number of hardware and/or software components configured to perform the specified functions. For example, the present invention may employ various integrated circuit (I.C.) components, e.g., memory elements, processing elements, logic elements, look-up tables, and the like, which may carry out a variety of functions under the control of one or more microprocessors or other control devices. Similarly, the software elements of the present invention may be implemented with any programming or scripting language such as C, C++, Java, COBOL, assembler, PERL, or the like, with the various algorithms being implemented with any combination of data structures, objects, processes, routines or other programming elements. Further, it should be noted that the present invention may employ any number of conventional techniques for data transmission, signaling, data processing, network control, and the like. Still further, the invention could be used to detect or prevent security issues with a scripting language such as JavaScript, VBScript or the like. Also, connecting lines between systems, e.g. as shown in the various figures contained herein, are intended to represent exemplary functional relationships and/or physical couplings between the various elements (and systems shown without any actual lines on a drawing may be so connected, wired or wirelessly). It should be noted that many alternative or additional functional relationships or physical connections may be present in a practical electronic transaction system. A network can include existing proprietary networks or can be a closed network that is assumed to be secure from unauthorized monitoring.

Software (e.g., computer apps) useful in implementing the present invention may be stored in the non-volatile memory and/or a drive unit. As used herein, a software program or app is assumed to be stored at any known or convenient location (from non-volatile storage to hardware registers) when the software program is referred to as “implemented in a computer-readable medium.” A processor is considered to be “configured to execute a program” when at least one value associated with the program is stored in a register readable by the processor.

As will be appreciated by one of ordinary skill in the art, who is enlightened by the teachings and suggestions of the present invention, the present invention may be embodied as a method (step or steps, element or elements), a data processing system, a device for data processing, and/or a computer program product. Accordingly, the present invention may take the form of an entirely software embodiment, an entirely hardware embodiment, or an embodiment combining aspects of both software and hardware. Furthermore, the present invention may take the form of a computer program product on a computer-readable storage medium having a computer-readable program code means embodied in the storage medium. Any suitable computer-readable storage medium may be utilized, including hard disks, CD-ROM, optical storage devices, magnetic storage devices, flash card memory, and/or the like.

In certain aspects a computer system suitable for implementing one or more embodiments of the present invention may be a personal computing device (e.g., smart phone, a computing tablet, a personal computer, laptop, PDA, Bluetooth device, key FOB, badge, handheld device, etc.) capable of communicating with other systems, other devices, and/or a network. A centralized function and/or entity and/or agency may utilize a network computing device (e.g., a network server) capable of communicating with the network. It should be appreciated that each of the devices utilized by users may be implemented as computer system, e.g., as described below.

Components of such a computer system can also include a system memory component (e.g., RAM), a static storage component (e.g., ROM), and/or a disk drive. The computer system can perform specific operations by a processor and other components by executing one or more sequences of instructions contained in a system memory component. Logic may be encoded in a computer readable medium, which may refer to any medium that participates in providing instructions to the processor for execution. Such a medium may take many forms, including but not limited to, non-volatile media, volatile media, and transmission media. In various implementations, non-volatile media includes optical or magnetic disks, volatile media includes dynamic memory, such as a system memory component, and transmission media includes coaxial cables, copper wire, and fiber optics, including wires that include a bus. In one embodiment, the logic is encoded in non-transitory computer readable medium. In one example, transmission media may take the form of acoustic or light waves, such as those generated during radio wave, optical, and infrared data communications. Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In certain embodiments of the present disclosure, execution of instruction sequences to practice the present disclosure may be performed by a computer system. In various other embodiments of the present disclosure, a plurality of computer systems coupled by communication link to a network (e.g., such as a LAN, WLAN, PTSN, and/or various other wired or wireless networks, including telecommunications, mobile, and cellular phone networks) may perform instruction sequences to practice the present disclosure in coordination with one another.

In certain aspects systems and methods according to the present may be described herein in terms of functions, functional components, flow pathways, optional selections and various processing steps. It should be appreciated that such steps may be realized by any number of hardware and/or software components configured to perform the specified functions. For example, the present invention may employ various integrated circuit components, e.g., memory elements, processing elements, logic elements, look-up tables, and the like), which may carry out a variety of functions under the control of one or more microprocessors or other control devices. Similarly, the software elements of the present invention may be implemented with any programming or scripting language such as C, C++, Java, COBOL, assembler, PERL, XML, ActiveX, or the like, with the various algorithms being implemented with any combination of data structures, objects, processes, routines or other programming elements. Further, it should be noted that the present invention may employ any number of conventional techniques for data transmission, signaling, data processing, network control, and the like.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

In some embodiments, a system (or any system herein according to the present invention) may include one or more of various types of devices, including, but not limited to a personal computer system, desktop computer, laptop, notebook, netbook computer, mainframe computer system, handheld computer, workstation, network computer, application server, storage device, a consumer electronics device such as a camera, camcorder, set top box, mobile device, video game console, handheld device, a peripheral device such as a switch, modem, router, phone, smartphone, cellphone, tablet or, in general, any type of computing or electronic device. Often typically, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio player, Global Positioning System (GPS) receiver, a digital camera, to name just a few. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry. To provide for interaction with a user, embodiments of the subject matter described in this specification can be implemented on a computer having a display device, e.g., a screen or a monitor, or a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

As used herein an computer “engine” or “system” can include a dedicated or shared processor and, typically, firmware or software modules that are executed by the processor. Depending upon implementation-specific or other considerations, an engine or system can be centralized or its functionality distributed. An engine or system can include special purpose hardware, firmware, or software embodied in a computer-readable medium for execution by the processor. Limited to the U.S. and to any other jurisdiction that has similar restrictions and/or legal limitations, a “computer-readable medium” can include all mediums that are statutory (e.g., in the United States, under 35 U.S.C. 101), and to specifically exclude all mediums that are non-statutory in nature to the extent that the exclusion is necessary for a claim that includes the computer-readable medium to be patentable. Known statutory computer-readable mediums include hardware (e.g., registers, random access memory (RAM), non-volatile (NV) storage, to name a few), but may or may not be limited to hardware.

In certain aspects a networked system is used in a method according to the present invention and the networked system is configured to implement a method or steps thereof in accordance with an embodiment of the invention. Such a networked system can include a user device, and a server or servers in communication over a network. A user utilizes a user device to perform a method using the server(s). The network may be implemented as a single network or a combination of multiple networks. For example, in various embodiments, the network may include the Internet or one or more intranets, landline networks, wireless networks, and/or other appropriate types of networks.

Although the terms “online” or “internet” are used herein to refer to a computerized network, a network may include any system for exchanging data or transacting business, such as the Internet, an intranet, an extranet, WAN, LAN, satellite or wireless communications, and/or the like. In addition, communications can be achieved via one or more wireless networks, such as, but is not limited to, one or more of a Local Area Network (LAN), Wireless Local Area Network (WLAN), a Personal area network (PAN), a Campus area network (CAN), a Metropolitan area network (MAN), a Wide area network (WAN), a Wireless wide area network (WWAN), Global System for Mobile Communications (GSM), Personal Communications Service (PCS), Digital Advanced Mobile Phone Service (D-Amps), Bluetooth, Wi-Fi, Fixed Wireless Data, 2G, 2.5G, 3G networks, enhanced data rates for GSM evolution (EDGE), General packet radio service (GPRS), enhanced GPRS, messaging protocols such as, TCP/IP, SMS, MMS, extensible messaging and presence protocol (XMPP), real time messaging protocol (RTMP), instant messaging and presence protocol (IMPP), instant messaging, USSD, IRC, or any other wireless data networks or messaging protocols (as is true for any embodiment of the present invention).

Communication between persons or systems using and/or involved in methods according to the present may be accomplished through any suitable communication means, such as, for example, a telephone network, intranet, internet, point of interaction device (point of sale device, personal digital assistant, cellular phone, kiosk, and/or the like), online communications, off-line communications, wireless communications, and/or the like. One skilled in the art will also appreciate that, for security reasons, any databases, systems, or components of the present invention may consist of any combination of databases or components at a single location or at multiple locations, wherein each database or system includes any of various suitable security features, such as firewalls, access codes, encryption, de-encryption, compression, decompression, digital security systems and/or the like.

In certain embodiments of the present invention any computer application according to the present invention or one step or some steps of such an application is in a pubic portion of a computer network and is used in a system that includes the computer network, the network having an on-premises portion, the system including a database storing information, and a user device connected with the computer network. In one aspect, the user device accesses a computer application (or part thereof) hosted in the public portion of the network. In response to the user device accessing the computer application, the application generates return information (e.g., any information provided by any method and by any computer application herein according to the present invention). In one aspect, the user device then receives the return information and generates a request for data (public or private) based on all or based on at least a portion of the returned information and then the request is transmitted to the database which generates a response including the requested data. Optionally, the response is transmitted in an encrypted form from the database via the computer network to the user device. Optionally, there is a firewall separating a public portion of the computer network from an on-premises portion of the computer network and the database is a database storing private data behind the firewall.

In any system and method herein, a user device may, for example, be connected with a public portion of a network, or it may, for example, be connected with a private portion of a computer network. As used herein, ‘connected’ or ‘connection’ does not necessarily imply that a first element (e.g., the user device) is physically connected (e.g. by a cable or the like) with a second element (e.g., the computer network), but rather that data and/or signals may be transmitted between the first and second elements. Such connection may be facilitated by a cable, a wireless transceiver, or any other suitable means.

In certain aspects, if a user uses multiple devices (e.g., a laptop, a smartphone, a desktop), content on each of the multiple devices can be synchronized on a remote storage, e.g., on a host server such that the user can access content stored on different devices through a single device when connected to the host server.

In certain aspects, to implement the various applications, methods and steps described herein a user device is used (including but not limited to a handheld device as in FIG. 4) with a server or server(s) which may each include one or more processors, memories, and other appropriate components for executing instructions such as program code and/or data stored on one or more computer readable mediums. For example, such instructions may be stored in one or more computer readable media such as memories or data storage devices internal and/or external to various components of the system, and/or accessible over the network.

The user device (and user device may include any system of FIG. 4) may be implemented using any appropriate hardware and software configured for wired and/or wireless communication over a network. For example, in one embodiment, the user device may be implemented as a personal computer (PC), a smart phone, personal digital assistant (PDA), laptop computer, and/or other types of computing devices capable of transmitting and/or receiving data, such as an iPad.

The user device may include one or more browser applications which may be used, for example, to provide a convenient interface to permit the user to browse information available over a network. For example, in one embodiment, a browser application may be implemented as a web browser configured to view information available over the Internet.

The user device may further include other applications as may be desired in particular embodiments to provide desired features to the user device. For example, and not by way of limitation, an application may be included that presents a result of any processing by any system herein or a total for any particular entity.

The server or servers may be maintained, for example, by an entity involved in any step of any method herein. In one aspect, the server(s) includes appropriate database(s).

In certain embodiments, the present invention provides a method and corresponding computer application, the method of using a “cloud computing” version of the application within a computer network environment, the method including the steps of: storing data in a database included in an on-premises portion of a computer network, wherein the on-premises portion is optionally behind a firewall separating the on-premises portion of the computer network from a public portion of the computer network; accessing with a user device (e.g., but not limited to, any personal device or handheld device described or referred to herein) connected with the computer network a computer application (any disclosed herein) hosted by one or more computer hardware platforms included in the public portion of the computer network; receiving at the user device return information from the application; transmitting a request for data (private and/or public) from the user device through the public portion of the computer network to the database of the on-premises portion of the computer network, wherein the request for data is based on at least a portion of the returned information; retrieving the requested data from the database in response to the request; transmitting the retrieved data, optionally in an encrypted form, via the public portion of the computer network to the user device. Optionally in such a method of accessing with a user device includes operating a mobile handheld device connected to the computer network via at least one of a Wi-Fi network connection, a cellular telephone network connection and a satellite network connection. Optionally, in any such method, in the step of accessing with a user device, the user device is connected with a private portion or with a private portion of the computer network.

The present invention provides, in some embodiments, a computer network system integrating secure data with public “cloud computing” capability, the system including: a public portion of the network and a private portion of the network, an optional firewall separating a public portion of the computer network from an on-premises portion of the computer network; a database storing data, (public and/or private) wherein the database is included in the on-premises portion and, optionally is behind a firewall; and a user device connected with the computer network, the user device being configured to access a public cloud application hosted by one or more computer hardware platforms included in the public portion of the computer network, the public cloud application being a computer application according to the present invention (any described herein) wherein the public cloud application is configured to generate return information after being accessed by the user device; the user device being further configured to receive the return information and generate a request based on all or on at least a portion of the returned information, wherein the request is transmitted through the public portion of the computer network to the database of the on-premises portion of the computer network; and the database being configured to generate a response including the requested data, wherein the response is transmitted, optionally, in an encrypted form, from the database via the public portion of the computer network to the user device.

The present invention provides systems, methods, and corresponding computer applications for delivering requested information (“information” including: any information provided by any method or app herein according to the present invention), such a system in at least some aspects including: a central server providing a one or more services to a user's device and/or premises over a communication network with a gateway, e.g., a gateway, receiving the information and/or one or more services from a central server and accessing information and/or one or more targeted items thereby delivering the information and/or one or more services, optionally with one or more targeted items, to a user's device and/or premises device or appliance. Such a method may use, and such a system may include a computer application according to the present invention, or applications, on the user's device supplied by a primary service provider that executes on the user device interacting with the central server and/or home gateway. A user device and/or appliance can be selected printers, smartphones, tablet computers, desktop computers, laptop computers, televisions, media players, gaming systems, security cameras, energy management devices, home appliances, and combinations thereof—as is true for any personal device in any method and computer app according to the present invention.

In certain aspects, a computer program product storing computer instructions therein for instructing a computer to perform a first process or step of a method according to the present invention, the program product including: a recording medium readable by the computer; and computer instructions stored on the recording medium instructing the computer to perform a step or a first process. In one such method the computer program product stores computer instructions therein for instructing a computer to perform a second process or step of determining that an action has occurred, that the action requires another action, and of making a determination, the program product further including computer instructions stored on the recording medium instructing the computer to perform the second process or step.

In certain aspects, the present invention provides a computer-implemented method for installing and using and installing a computer application module on a user device, the computer application including any computer application according to the present invention, the method including: reading, by a computer, information from a user device in response to receiving a request for a computer application according to the present invention to effect a purpose of the computer application, including—but not limited to—a step or steps of a method according to the present invention; determining, by the computer, that a desired computer application module according to the present invention is not present on the user device based on the information read from the user device; a first communicating, by the computer, communicating a form for presentation on the user device in response to determining that a desired computer application module according to the present invention (“CAMATTPI”)is not present on the user device, the form comprising a request to install the CAMATTPI and, unless the CAMATTPI is free (which it may be in certain aspects), for payment information to install the CAMATTPI, optionally this done with a digital wallet and/or with installation of a digital wallet; receiving, by the computer, information from the user device regarding the first communicating; a second communicating, by the computer, communicating a request to, optionally, install a digital wallet module on the user device based on determining that a digital wallet module is not present on the user device; receiving, by the computer, an acceptance from the user device of the request to install the CAMATTPI and/or the digital wallet module on the user device; a third communicating, by the computer, communicating the CAMATTPI and/or the digital wallet module to the user device for installation on the user device in response to receiving the acceptance; and a fourth communicating, by the computer, communicating any payment information, if it exists, to the user device for storage in connection with the CAMATTPI and/or the digital wallet module; and a user using the CAMATTPI to effect a method funding according to the present invention and/or to effect a goal of a CAMATTPI other than an account funding. Such a method may be effected without a digital wallet.

The present invention provides a computer program product, including: a non-transitory computer-readable medium having computer-readable program code embodied therein for completing a step or steps of a method according to the present invention, the computer-readable medium including: computer-readable program code for reading a user device in response to receiving a request for information to complete the step or steps; computer-readable program code for determining a CAMATTPI module is resident on the user device based on the information read from the user device, wherein the CAMATTPI module is, optionally, embedded in a web browser; computer-readable program code for authorizing a request to submit information from the CAMATTPI module resident on the user device; computer-readable program code for establishing a secure connection with the CAMATTPI module resident on the user device; computer-readable program code for submitting to the CAMATTPI module resident on the user device, a request for information to complete the step or steps, the request originating from a user or from a source website; computer-readable program code for receiving the information from the CAMATTPI module; optional computer-readable program code for submitting an authorization request to a source or to an entity, wherein the source or the entity corresponds to the information provided by the CAMATTPI module; and computer-readable program code for receiving an authorization for the request from the source or the entity the step or step in accordance with the information.

FIG. 5 illustrates a method 500 according to the present invention which begins with the discovery of a thing (“DISCOVER THING”) which has at least one identifier and, in certain aspects, a plurality of identifiers. The identifiers may be any identifiers, or combination of different identifiers, disclosed herein for identifying the thing. In one aspect, the thing is a piece or part of a vehicle, and, in one particular aspect, is a part of a tire of a vehicle. The thing may be discovered visually, by chancing upon it, by accident, or purposefully with detection equipment. A system according to the present invention with GPS capability provides, notes and stores a precise location of the thing (“LOCATE THING”). This system—and any other system used for the method 500—may be a computerized system that employs a computer program or computer app to perform its functions. This system may be, e.g., an electronic phone; a computer; a computer device; or any of the suitable systems of FIG. 4.

This same system that locates the thing, or another system, accesses the identifier(s) and identifies the thing (“IDENTIFY THING”). This system may be an electronic phone; a computer device; or any of the suitable systems of FIG. 4. The type or form of accessing the identifier(s) depends on the type of identifier(s) present. Suitable accessing is within the scope of the present invention; e.g., scanning of barcodes or bocodes or other coded information; interrogation or activation of active tags or active electronic identifiers, tags, or chips with a suitable reader, scanner, or interrogator; visual review of visually identifiable words, symbols, numerals, or indicia; or analysis of material and/or structure used as an identifier.

The same system that identifies the thing, or another system, retrieves information (“RETRIEVE INFORMATION”) from the thing's identifier(s) after accessing of the identifier(s). This information may be any, some, or all of the information described herein that can be provided by an identifier, and all the types and categories of information described or referred to in references herein directed to an identifier. The same system that retrieves the information, or another system, stores and, optionally, processes the information (“STORE/PROCESS INFORMATION”) obtained in retrieving the information. Storage may be in any suitable computer storage media, medium, or device. The processing of the information may be to provide a processing result which may be any of the processing results described herein; e.g., but not limited to, those described following the sensing or detection of a piece in FIG. 4. the system used in any previous step, or another system, can provide any person, entity, and/or other system with a signal indicative of any of the information from the thing's identifiers and/or any result of the processing of information (“SIGNAL”). Such a signal may be any signal, etc., described above.

In one particular embodiment of a method 500, a person with a handheld computer device discovers a part of a retread tire on the shoulder of a highway. The part has multiple electronic identifiers that can be actively activated and accessed using an appropriate reader that is incorporated into the handheld device. The person activates the identifiers and then notes and records the GPS location of the part using the handheld device. Also, the person notes and records the identity of the thing as a part of a tire and retrieves the information provided by the identifiers. All the information is stored in the handheld device which then processes the information for transmission by the handheld device in a signal or signal(s) to another system which receives, accumulates, stores, and further processes and uses the information. Later the person can access the retrieved information and/or processing results on the handheld device and/or can transmit it to another device or system.

A method 510, shown in FIG. 5B, has some steps that are like steps of the method 500: the steps of DETECT THING; IDENTIFY THING/LOCATE THING; RETRIEVE/STROE/PROCESS INFORMATION; AND SIGNAL. The method 510 also includes a step of determining the conditions (“DETERMINE/RECORD CONDITIONS”) under which the thing is detected (or discovered)—conditions such as date, time of day, weather conditions, road conditions, traffic conditions, and/or condition of thing detected (e.g., used, new, broken, scraped, bent, whole, discolored, rusted, dirty). A system used for such determining may be any system used or referred to in the description of the method 500 or in the description of FIG. 4. A handheld computer device may be used for the determination and the information for the basis of the determination as well as the determination itself may be recorded in the handheld device or in any suitable storage medium of any system used in the method.

The method 510 includes collection of the thing (“COLLEDT THING”), which is the actual pickup, loading, acquiring or gathering of the thing. The method 510 includes transporting of the thing (“TRANSPORT THING”) which is the carrying away, removal, trucking away or trailering away of the thing. Either at the site of detection or at a remote site, the thing is processed (“PROCESS THING”). This processing may include another identification of the thing and/or actual physical processing such as, but not limited to, cleaning, pulverizing, comminuting, breaking down, neutralizing, chemical treatment, inspecting, sanitizing, packaging, addressing, and/or analyzing.

The method 510 then includes either disposal of the thing or return of the thing to an entity associated with the thing (“DISPOSE OF OR RETURN THING TO AN ASSOCIATED ENTITY”). Optionally, the thing is sent to an un-associated entity, e.g., for refurbishing, rebuilding, further processing, or disposal. In one particular aspect, the thing is a part of a retread tire and it is sent to the entity that retreaded the tire.

Any of the steps of the method 510 that can be done, facilitated or implemented by a computer can have a related computer app for the implementation (as is true for any step or steps of any method herein, e.g., but not limited to, the methods of FIGS. 4-8). Also, a signal, etc. may be provided to any appropriate entity related to the detection, collection, transport, processing, disposal, and/or return of the thing.

It is within the scope of the present invention for government entities to be involved with the detection, collection, return of, and disposal of things that are separated from vehicles; and for such entities to contact, warn, ticket, notify, and/or invoice or fine an entity whose property or cargo litters or obstructs a roadway or areas adjacent to it. A method 600 shown in FIG. 6 begins with discovery/detection of a thing (“DISCOVER THING”), identification of the thing and retrieval of information from identifier(s) in and/or on the thing (“IDENTIFY THING” and “RETRIEVE INFORMATION”, e.g. as described above for the methods of FIGS. 4-5B, and the creation of and transmission of a signal, etc. to a concerned government entity (“SIGNAL TO GOVERNMENT ENTITY”).

Such a government entity (e.g., a law enforcement entity; road maintenance, sweeping, mowing, litter-pickup, or cleaning entity; environmental entity; or work crew entity), receives the signal information about the thing, processes the information, and prepares notice(s) for the appropriate party or parties (“ENTITY PROCESSES SIGNAL INFORMATION & PREPARES NOTICE”).

According to the present invention, the “notice” may be any appropriate communication from the government entity to any party associated with the thing, including, but not limited to, a notice of the detection of the thing and the circumstances thereof; a notice of the collection, disposal, and/or return of the thing; a ticket with a fine or fee related to the presence of the thing on or near a roadway, e.g., but not limited to, a ticket for littering; a notice of a party's previous things found on or near a roadway and dealt with by this or some other government entity—in one aspect with a total or totals for this entity regarding one or all of total number of things detected, total volume of things detected, total weight of things detected; an invoice for any government action regarding the thing(s), including, but not limited to, detection, collection, processing, disposal, and or return of the thing(s); and/or an invoice for damage to the roadway, to government property and/or injury to personnel. Optionally, in any method herein, a private entity may send any such notice to any associated party.

In one aspect, instead of “GOVERNMENT ENTITY,” the entity that produces and/or sends the notice is a private entity, e.g., but not limited to, an insurance company. In another aspect, the “SIGNAL” (and this is true of any “signal etc.” herein) is transmitted to a private entity, e.g., but not limited to, an insurance company with a relation to any associated party and/or with a relation to anyone whose property has been damaged or with a relation to anyone who has been injured or died.

Any of the steps of the method 600 that can be done, facilitated or implemented by a computer can have a related computer app for the implementation which, when done with a suitable computer or computer device, accomplishes functions of the step or steps (as is true for any step or steps of any method herein).

It is within the scope of the present invention, when the “thing” which is a subject of a method according to the present invention has identifiers with computer media that are programmable, to change, add to information, install, or reprogram an identifier or identifiers that has been detected or discovered and from which information has been retrieved so that the identifier(s) contain information that the thing has already been identified, etc. before. In this way, when there is a subsequent discovery or detection of the thing, it will be evident, easily discernible, and known that the thing has been discovered or detected previously. In one particular aspect, when payments are made related to such a thing's detection, retrieval, processing, return and/or disposal, it will be clear that such thing was previously detected, etc., and, in certain aspects, that payments have been previously made, e.g., if the thing is again detected or presented for payment. In one particular aspect, subsequent interrogation and/or scanning and/or reading of an identifier is made impossible; or after any chosen number of interrogations, etc., subsequent interrogations, etc. are made impossible, e.g., by appropriate reprogramming of programmable media included with the identifier(s).

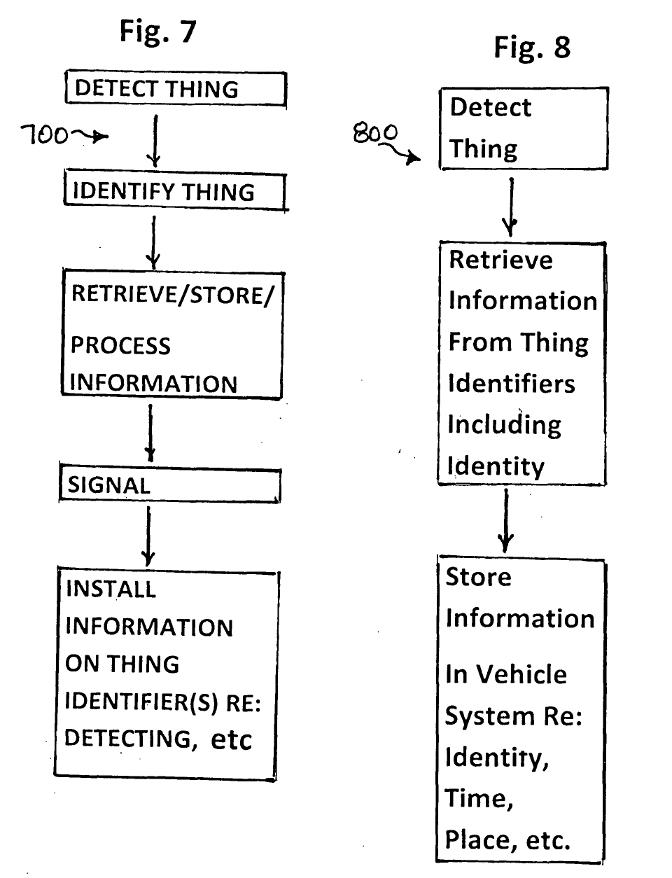

As shown in FIG. 7, a method 700 according to the present invention provides for the reprogramming of identifier(s) of a detected thing to indicate that the thing has been detected, etc. (“INSTALL INFORMATION ON THING IDENTIFIERS(S) RE: DTECTING, etc”). The other steps in the method 700 are like those of the methods in FIGS. 4, and 5A-6, which descriptions are repeated here. Any of the steps of the method 700 that can be done, facilitated or implemented by a computer can have a related computer app for the implementation which, when done with a suitable computer or computer device, accomplishes functions of the step or steps. It is within the scope of the present invention, if a thing's identifier(s) are not reprogrammable, to alter them, change them, or add to them so that they include an indication that the thing has been detected or discovered previously; e.g., but not limited to, by adding a code, a symbol, or a physical indicator.

It is within the scope of the present invention for a vehicle to have equipment including detection apparatus or device(s) for detecting a thing with identifiers, and information retrieval and storage apparatus and device(s)so that when the vehicle encounters a thing on a roadway, the thing is detected and identified, and the information related to this is stored in apparatus, memory, and/or device(s) in or on the vehicle. In certain embodiments, the apparatus, etc. in which the information is stored is hardened and/or armored so that it will withstand and survive an impact or a wreck. In this way, if a thing is a cause or part of a cause of damage or injury to the vehicle or its occupants, details of the thing, its identity, and some circumstances of the encounter with it will be stored in the apparatus, etc., for retrieval after the impact or wreck.

FIG. 8 shows a method 800 according to the present invention in which an apparatus, etc., in or on a vehicle has storage media (e.g., any suitable known computer storage media) in which can be stored information about a thing with identifier(s) and circumstances and details of the vehicle's encounter with such a thing. Upon such an encounter, the thing is detected (“Detect Thing”) and the information in the thing's identifier(s) is retrieved (“Retrieve Information From Thing Identifiers Including Identity”). Such information can be and include any and all information disclosed herein that can be in or on an identifier. The system or systems used to accomplish this can be any disclosed herein, e.g., but not limited to, those of the automobiles of FIG. 4. The retrieved information is stored in a system or systems on the vehicle (“Store Information In Vehicle System Re: Identity, Time, Place, etc.”) which can be any suitable device with suitable storage media, any system disclosed herein, and any system of the automobiles of FIG. 4.

Such stored information may be used for any purpose, but in particular it can prove useful in the event that the thing impacts the vehicle and/or damages it, or when encountering it results in injury or death to an occupant of the vehicle. “Encountering it” can include both actually hitting the thing and efforts taken to avoid the thing, whether there is an impact or not. Any of the steps of the method 800 that can be done, facilitated or implemented by a computer can have a related computer app for the implementation which, when done with a suitable computer or computer device, accomplishes functions of the step or steps.

Any computer app herein may be installed on any suitable computer or computerized device or computer apparatus, or on any suitable electronic phone, cellphone, or smartphone.

The inventor claims, inter alia, the subject matter of the specific numbered claims below.

1.-30. (canceled)

31. A method for identifying a part of a vehicle, the vehicle having a plurality of components and each component having a plurality of parts, each part having at least one identifier, each identifier containing identifying information, the method comprising
detecting a part, he part having at least one identifier,
accessing identifying information in the at least one of the identifiers of the part, and
utilizing the identifying information to assign responsibility to an entity related to the part.

32. The method of claim 31 wherein the part is separated from the vehicle.

33. The method of claim 31 wherein the vehicle has tires and the part is a part of one of said tires separated from said tire.

34. The method of claim 33 wherein the tire has tread and the part of the tire is part of the tread.

35. The method of claim 31 wherein assigning responsibility is assigning responsibility for damage from encountering the part, wherein the damage is one of damage to property, physical injury, and death of a person.

36. The method of claim 31 further comprising
retrieving information from at least one identifier of the part,
storing and processing the information, and
making and sending a signal with information about the part based on the information retrieved to an entity.

37. The method of claim 36 further comprising
determining a location of the part,
storing the location in storage media, and
including the location in the information of the signal.

38. The method of claim 31 further comprising
performing an action related to the part based on the identifying information,
the action being one of or a combination of: locating the part; accessing information in an identifier of the part; processing said information; collecting the part; transporting the part; returning the part to an associated party; disposing of the part; , sending a notice to an associated party about the part; sending a notice to a government entity about the part; installing information on an identifier of the part that the identifier was subject to any of access; and providing information from the part's identifier to an insurance company.

39. The method of claim 31 wherein the part is a part of a tire with multiple tire parts, each tire part of the tire has identifiers, the tire parts include these tire parts: crown, tread, bead, reinforcement material, sidewall, and shoulder; and each tire part has at least one identifier which provides information about which part of the tire the tire part is.

40. The method of claim 31 further comprising providing to an associated party a notice about the part, the notice including information regarding a payment due from the associated party.

41. The method of claim 31 wherein there are sufficient identifiers in or on the thing so that when a part or piece of the thing is separated from the thing, the part or piece has at least one identifier.

42. The method of claim 31 wherein each component has sufficient identifiers so that a part separated unintentionally from the component has at least one identifier.

43. The method of claim 42 wherein the part is a part of a tire, and the at least one identifier is a plurality of spaced-apart identifiers.

44. The method of claim 43 wherein the part is a retread portion of a tire and the plurality of spaced-apart identifiers are spaced apart by a spacing that is one of: one identifier for every square inch of said retread portion, one identifier for every four square inches of said retread portion, and one identifier for every twelve square inches of said retread portion.

45. The method of claim 31 the component has a component-identifying identifier and the part has a part-identifying identifier.

46. The method of claim 31 wherein the vehicle has tires, the tires have tread parts, and the part is a tread part of a tire, the tread parts at different depths of tread, each tread part having specific identifiers.

47. A computer program product comprising:
a non-transitory computer-readable medium having computer-readable program code embodied therein for completing steps of a method,
the method comprising a method for identifying a part of a vehicle, the vehicle having a plurality of components and each component having a plurality of parts, each part having at least one identifier, each identifier containing identifying information, the method including
detecting a part, he part having at least one identifier,
accessing identifying information in the at least one of the identifiers of the part, and
utilizing the identifying information to assign responsibility to an entity related to the part.

48. The computer program product of claim 47 wherein the computer program product is resident on a portable computer, a portable computer device, a handheld device, a cellphone, or a smartphone.

49. A tire which is a component of a vehicle, the tire comprising
tire parts including crown, tread, bead, reinforcement material, sidewall, and shoulder,
each tire part having at least one identifier identifying the tire part, and
the vehicle being one of truck, automobile, trailer, RV, and airplane.
